(19) United States
(12) Patent Application Publication
(10) Pub. No.: US 2008/0010491 A1
(43) Pub. Date: Jan. 10, 2008

(54) Event Information Managing Method Related to Events Occurring in Image Forming Device and Server Computer

(75) Inventor: Koji KITA, Tokyo (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/608,984

(22) Filed: Dec. 11, 2006

(30) Foreign Application Priority Data
Jun. 16, 2006 (JP) 2006-167496

(51) Int. Cl. G06F 11/00

(52) U.S. Cl. 714/4

(57) ABSTRACT

The MFP transmits event information to the server computer. The server computer then constructs a user-reviewable database using the received event information. A PC consults with the server computer concerning the information based on the database. The PC transmits additional information, which is to be prepared by the user and to be added to the database, to the server computer.

### CROSS-REFERENCE TO RELATED APPLICATION

This application is based on Japanese Patent Application No. 2006-167496 filed on Jun. 16, 2006, the contents of which are incorporated herein by reference.

### BACKGROUND

The present invention relates to an event information managing method for managing event information concerning events occurring in an image forming device and a server computer for managing the information.

When troubles such as shortage of toner occur on an image forming device such as a printer, it may be necessary for the user of the image forming device to take a proper action immediately by contacting the service company managing the image forming device.

A remote control system has been proposed for the purpose of responding to such an event occurring in an image forming device more quickly by remotely managing such an image forming device installed at the user's site, via a communication channel, by a remote control device that is managed by a service company. See Japanese Unexamined Publication No. 2004-86033. When information indicating the status of the particular image forming device arrives at the remote control device in the remote control system, the remote control device obtains the information and displays it on a screen to display information to the operator at the control center. The operator will take a proper action based on the displayed information.

However, the abovementioned remote control system relates a large scale remote system developed by the vendor of image forming devices for supporting each image forming device. Therefore, one associated problem is the expense to introduce, manage, and operate the remote system.

Moreover, since such a system is dedicated for the benefit of the device vendor company or service company, it could not respond to the user side's demand for managing the operating status of the image forming device by the user themselves.

### OBJECTS AND SUMMARY

It is an object of the present invention to provide a system having a simple structure that enables a user to manage events occurring in an image forming device, which is improved for solving the abovementioned problems.

According to one embodiment of the invention, there is provided an event information management method for managing event information in a system, the event information concerning events occurring in an image forming device, the system equipped with said image forming device, a server computer communicable with said image forming device, and a terminal device communicable with said server computer. The event information management method comprises: 1) said image forming device transmitting said event information to said server computer; 2) said server computer constructing a user-viewable database using the received event information; 3) said terminal device consulting with said server computer for information based on said database and 4) said terminal device transmitting additional information, which is to be prepared by the user and to be added to said database, to said server computer.

According to another embodiment of the invention, there is provided a server computer communicable with an image forming device and a terminal device. The server computer comprises a network interface adapted to communicate with the image forming device and the terminal device; and a control unit adapted to control the server computer. The control unit receives event information concerning an event generated in the image forming device from the image forming device through the network interface, and constructs user-viewable database using the event information. Moreover, the control unit receives additional information, which is to be prepared by the user and to be added to said database, from the terminal device used for viewing of information based on said database to update said database.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram showing the overall structure of a printing system pertaining to a preferred embodiment of the present invention.

FIG. 2 is a block diagram showing the structure of a PC.

FIG. 3 is a block diagram showing the structure of a server computer.

FIG. 4 is a block diagram showing the structure of an MFP.

FIG. 5 is a flowchart showing the process sequence of the MFP.

FIG. 6 is a diagram showing a setup table for events.

FIG. 7 is a diagram showing a reference table related to the occurrence of an event.

FIG. 8 is a flowchart showing the process sequence of the server computer.

FIG. 9 shows an example of the database constructed at the server computer.

FIG. 10 shows an example of the comment setup screen to be displayed on the PC.

FIG. 11 is a diagram for describing the method of using viewable database.

### DETAILED DESCRIPTION OF PREFERED EMBODIMENTS

Some exemplary embodiments will be described below with reference to the accompanying drawings.

FIG. 1 is a block diagram showing an example of an overall structure of a printing system. The printing system shown in FIG. 1 is equipped with a PC (personal computer) 10 as a terminal device, a server computer 20, and MFP (Multi-Function Peripheral) 30A, 30B as image forming devices.

The PC 10, the server computer 20, and the MFP 30A, 30B are interconnected via a network 40 to be able to communicate with one another. The network 40 consists of a LAN consisting of interconnected computers and network equipment in accordance with standards such as Ethernet (registered trademark), Token Ring, FDDI, or a WAN consisting of multiple interconnected LANS. The types of and the number of devices that are connected to the network 40 are not limited to those shown in FIG. 1.

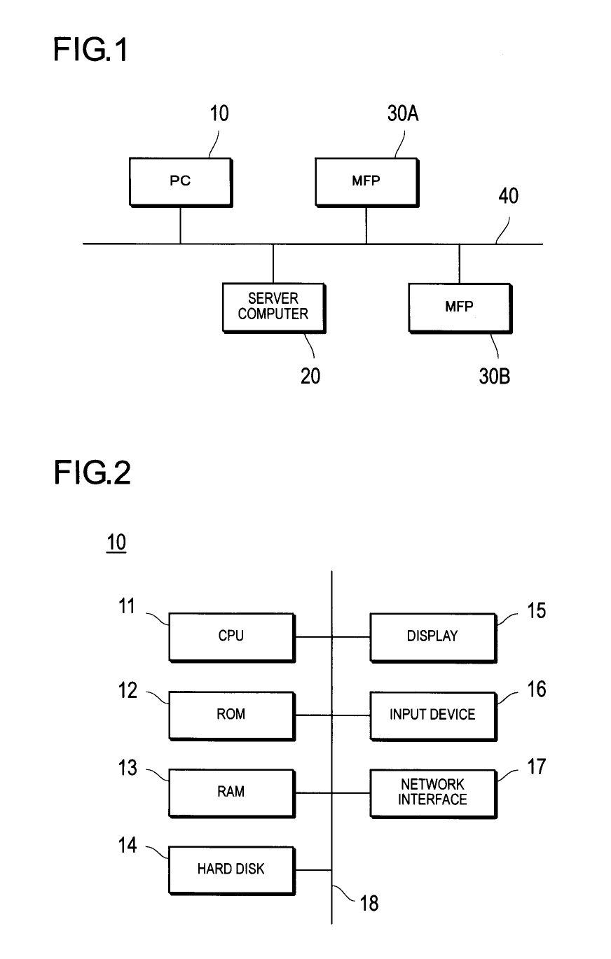

FIG. 2 is a block diagram showing an exemplary structure of a PC 10.

The PC 10 is equipped with a CPU 11, a ROM 12, a RAM 13, a hard disk 14, a display 15, an input device 16, and a network interface 17, all of which are mutually interconnected via a bus 18 for exchanging signals.

The CPU 11 controls various parts mentioned above and executes various arithmetic processes. The ROM 12 stores various programs and various kinds of data. The RAM 13 stores programs and data temporarily as a work area. The hard disk 14 stores various kinds of programs including the operating system. A program that provides the Web browser function used for retrieving required information from the server computer 20 is installed in the hard disk 14.

The display 15 can be an LCD, CRT display, etc., and displays various information. The input device 16, which can contain a pointing device such as a mouse etc. and a keyboard, is used for entering various type of input.

The network interface 17 is an interface for communication with other devices via the network 40, to which various standards such as Ethernet (registered trademark), Token Ring, and FDDI are applied.

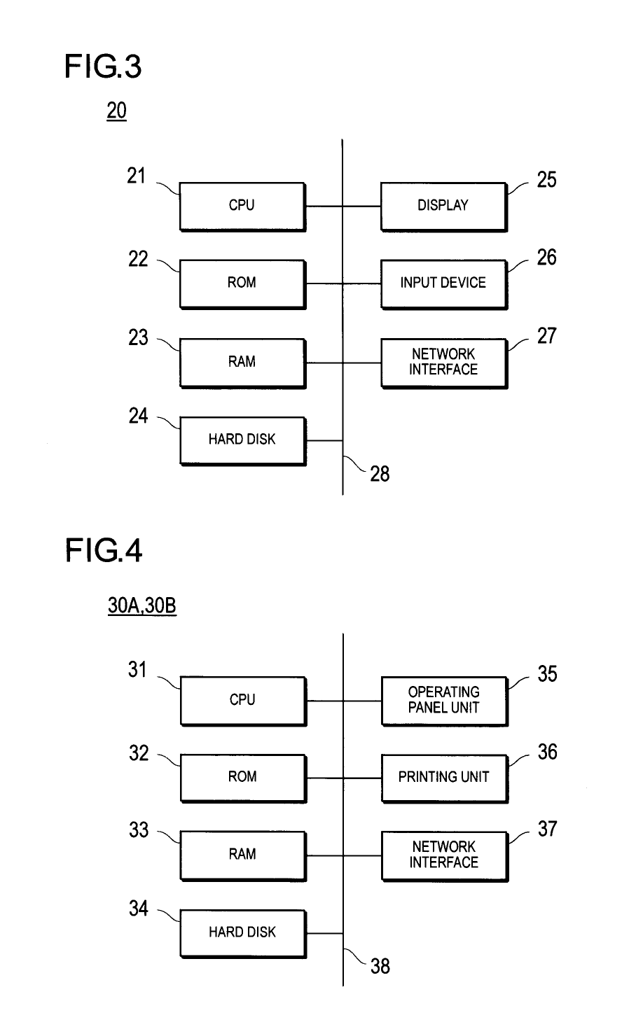

FIG. 3 is a block diagram showing an embodiment of the structure of the server computer 20. The server computer 20 is equipped with a CPU 21, a ROM 22, a RAM 23, a hard disk 24, a display 25, an input device 26, and a network interface 27, all of which are interconnected via a bus 28 for exchanging signals. Of various parts of the server computer 20, those that have identical functions as the similar parts of the PC 10 will not be described about here in order to avoid duplication.

A program that provides the Web server function is installed on the hard disk 24. In other words, the server computer 20 has a function of a Web server. The server computer 20 here is capable of publicizing information described in a markup language such as HTML, XML, and others on the Internet as database, and transfers the information based on the database in response to a request from a client in accordance with a protocol such as HTTP. For example, bulletin board function or blog function can be used in the present embodiment.

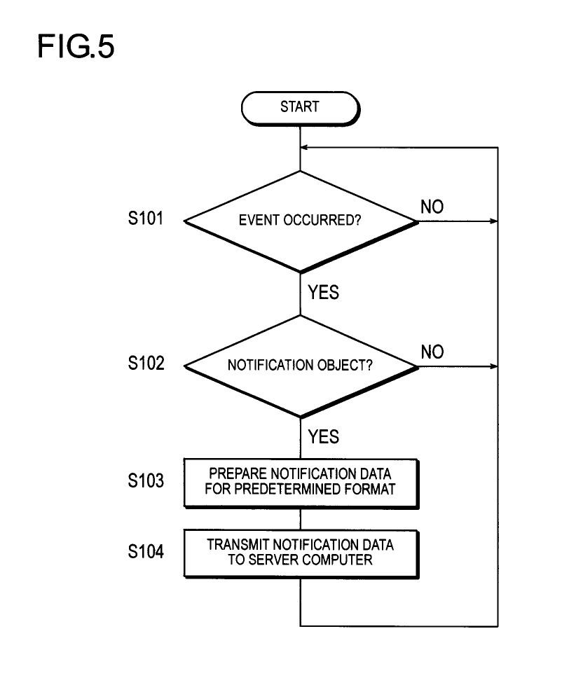

FIG. 4 is a block diagram showing an exemplary structure of the MFP 30A, 30B. The MFP 30A, 30B is equipped with a CPU 31, a ROM 32, a RAM 33, a hard disk 34, an operating panel 35, a printing unit 36, and a network interface 37, all of which are interconnected via a bus 38 for exchanging signals. Of various parts of the MFP 30A, 30B, those that have identical functions as the similar parts of the PC 10 will not be described about here in order to avoid duplication.

A program that provides an HTTP client function cab be used for transmitting to the server computer 20, the notification data containing the event information concerning an event that occurred in the MFP, is installed on the hard disk 34. Although this program is stored in the hard disk 34, in the present embodiment, it can be stored in the ROM 32 as well. The HTTP client function only needs to be able to transmit the notification data to the server computer 20 and does not necessarily have to have the transmission, reception, and display functions such as a Web browser.

The operating panel unit 35, containing a touch panel, fixed keys outside of the touch panel, and display lamps, can be used for making various inputs and displays. The printing unit 36 prints raster data obtained as a result of conversion on a recording medium such as paper by means of various printing methods such as the electronic photographic method.

The PC 10, the server computer 20, and the MFP 30A, 30B may contain other constituting members than those mentioned above, or may not contain a portion of those constituting members mentioned above.

The method of managing event information concerning the events occurred in the MFP 30A, 30B, which is executed in the printing system, is described below.

FIG. 5 is a flowchart showing an exemplary operating procedures in the MFP 30A. The algorithm shown in the flowchart of FIG. 5 is stored in the storage unit such as a hard disk 34 of the MFP 30A as a program, and executed by the CPU 31. Since the process in the MFP 30B is identical to the process in the MFP 30A, its description will be omitted.

First, the MFP 30A waits until an event occurs in the MFP 30A (step S101: No).

Then, when it determines that an event has occurred (step S101: Yes), it makes a judgment as to whether the particular event is set up as an object of notification to the computer 20 or not (step S101). If it judges that it is not an object of notification (step S102: No), the process returns to step S102. The objects of notification are selected from a plurality of items and preset by the user.

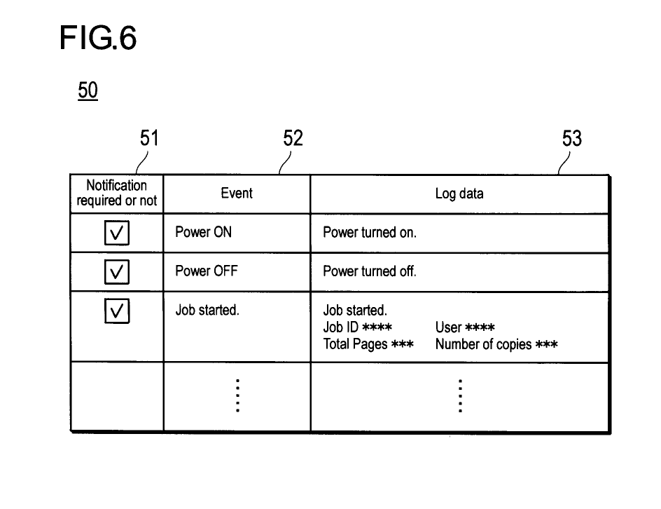

FIG. 6 is a diagram showing an example of setup table for events. The setup table 50 contains an event item column 52 and a check box column 51 for indicating that the particular item is an item selected by the user. The user can select an item to be notified about among a plurality of items via the operating panel unit 35 of the operating panel unit 35 of the MFP 30A. The setup table 50 contains a log data column 53 as well for indicating the log data corresponding to the contents of the event to be notified about when the event occurs.

The setup table 50 is set up for each MFP via the operating panel unit 35. However, the setup table 50 may be set up via the input device 26 of the server computer 20 all together to be transmitted to each MFP. Moreover, it can also be so constituted in that the entirety of the event information concerning the events that occurred in the MFP is transmitted to the server computer 20, and then a portion of the received event information is deleted in accordance with the setup table 50.

If a particular event is judged to be an object of notification in the step S102 (step S102: Yes), a set of notification data is prepared containing the event information of the particular event in accordance with a predetermined format (S103). Next, the prepared notification data is transmitted to the server computer 20 (step S104). Although the notification data is transmitted each time when an event occurs as mentioned above, it can also be constituted in such a way as to be transmitted at a predetermined time or at a predetermined interval.

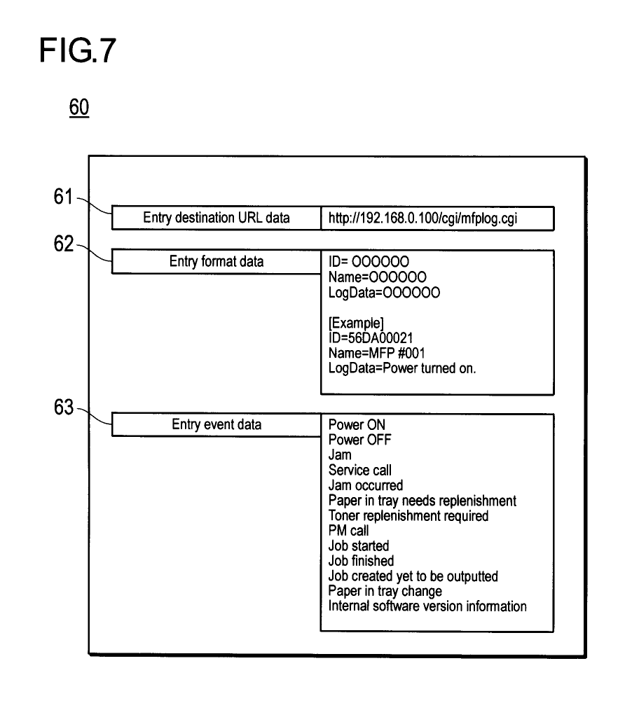

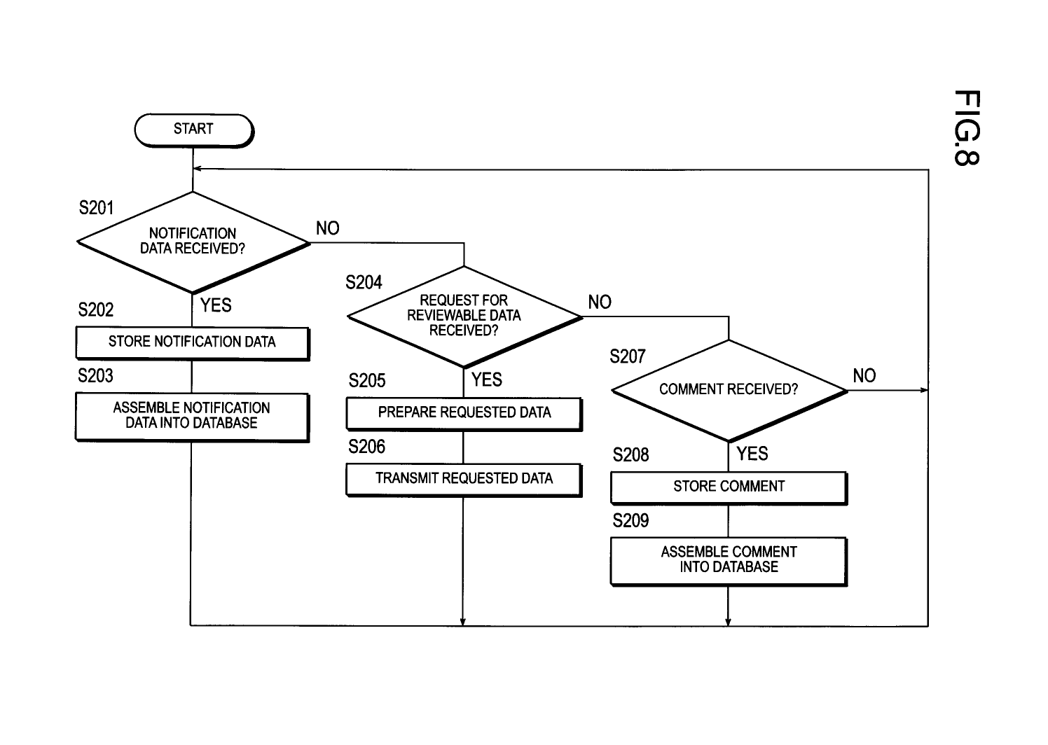

FIG. 7 is a diagram showing an example of a reference table related to the occurrence of an event. The reference table 60 contains “Entry destination URL data” 61 indicating the transmission destination address of the prepared notification data, “Entry format data” 62 indicating the format of the notification data, and “Entry event data” 63 indicating an event item preset as an object to be notified to the server computer 20. As shown in FIG. 7, the events in this specification represent various statuses of the MFP such as power source on/off, version information of the internal software products such as the printer driver, printing job start/finish, and warnings such as toner replenish request.

“Entry format data” 62 is specified in such a way that the notification data to contain the ID number and name of the MFP as well as the log data corresponding to the contents of the event. The specific data to be added as the log data is determined in correspondence with the log data column 53 of the setup table of FIG. 6. The notification data may contain other information such as date and time of the occurrence of the event in the MFP. “Entry event data” 63 consists of the event items check-marked in the check box column 51 of the setup table of FIG. 6.

FIG. 8 is a flowchart showing exemplary operating procedures of the server computer 20. The algorithm indicated by the flowchart of FIG. 8 is stored as a program in a memory unit such as the hard disk 24 of the server computer 20 and is executed by the CPU 21.

First, the server computer 20 makes a judgment whether it has received notification data from the MFP or not (step S201).

If the notification data has been received (step S201: Yes), the particular notification data will be stored in the memory unit such as the RAM 23 (step S202).

The server computer 20 then continues to analyze the received notification data, and enters the contents of said notification data (S203). In other words, the server computer 20 uses the received notification data to construct user-reviewable database 70.

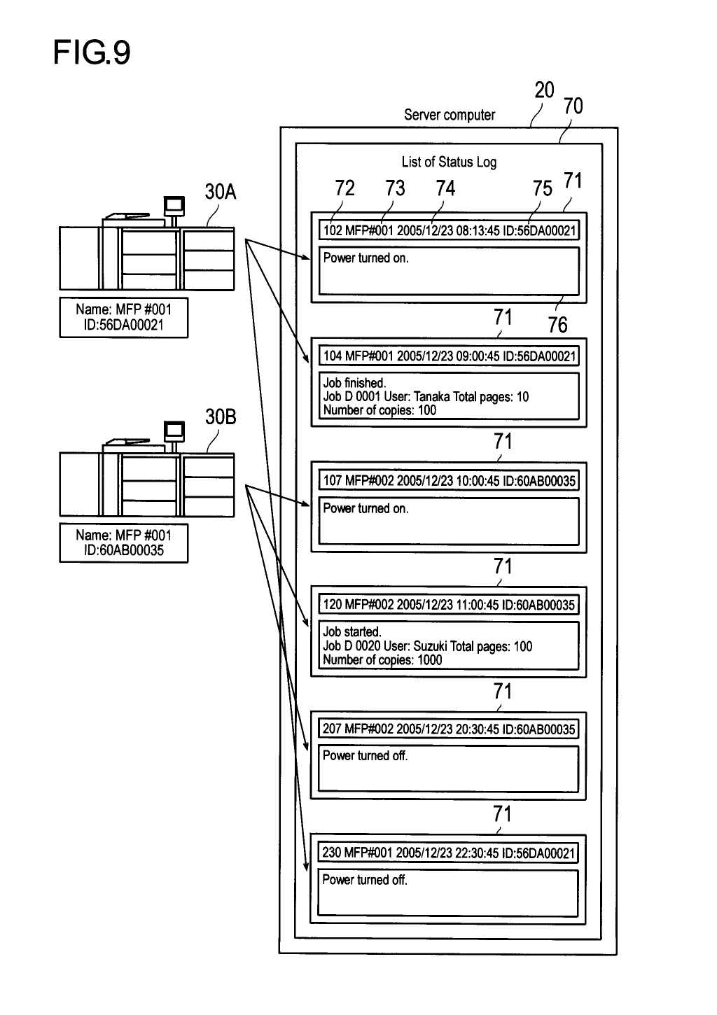

FIG. 9 shows an example of the database 70 constructed at the server computer 20. In the present embodiment, the database 70 contains the list of status notification logs and consists of the information arranged in a time series. Each status notification log 71 of the database 70 contains a serial number 72, MFP's name 73, notification reception date and time 74 at the server computer 20, MFP's ID number 75, and log data 76. The status notification log 71 may contain, in addition to the notification data reception date and time 74 at the server computer 20, the event occurrence date and time at the MFP, or the notification data transmission date and time at the MFP.

On the other hand, if it is judged that the notification data is not received in step S201 (step S201: No), the server computer 20 makes a judgment as to whether any request for reviewable data is received from the PC 10 or not (step S204).

If the request for the reviewable data is received (step S204: Yes), the server computer 20 prepares the requested reviewable data (step S205).

The server computer 20 then transmits the requested reviewable data to the PC 10 (step S206).

The PC 10 then receives the reviewable data, and displays it on the display 15 of the PC 10. The PC 10 may either request to the server computer 20 the entire list of status notification log at the database 70, or request only the status notification log containing the event information of the specific items specified by the user.

If it is judged that no request for reviewable data is received in step S204 (step S204: No), the server computer 20 makes a judgment as to whether any comment is received from the PC 10 or not (step S207).

If a comment is received (step S207: Yes), said comment is stored in a storage unit such as the RAM 23 (step S208).

Next, the server computer 20 enters the contents of the received comment into the database 70 as additional information (step S209). The comment is stored in the database 70 preferably in a form related to the specific event information contained in the database 70.

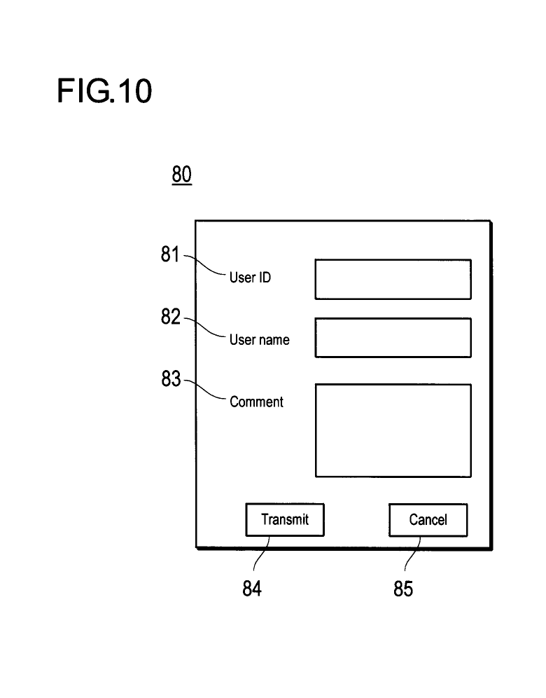

FIG. 10 shows an example of the comment setup screen to be displayed on the PC 10. The comment setup screen 80 is displayed when the user clicks a specific section of the status notification log 71 (see FIG. 9) in the list of status notification logs displayed on the display 15 of the PC 10. The comment setup screen 80 contains the user's ID, user's name, input boxes 81, 82 and 83 for entering the comment. When specific data is entered into each input box 81, 82 and 83 respectively and a transmission button 84 is depressed, the comment entered by the user is transmitted to the server computer 20 and said comment is added to the database 70. The comment is then preferably transmitted to an address which is different from the transmission destination address (URL) of the notification data selected at the time when the event occurred in the MFP, so that the comment can be treated separate from the notification data.

For example, when the version information of internally stored software is to be handled as a specific status notification log 71, the manager of the MFP can add to the database 70 a comment for notifying another user the storage location of the corresponding printer driver as additional information. This makes it possible for the other user to install the particular printer deriver to his/her own PC from storage location of the printer driver indicated in relation to the version information (e.g., new version information) of the internally stored software. When a cancel button 85 is depressed, the comment setup process is cancelled.

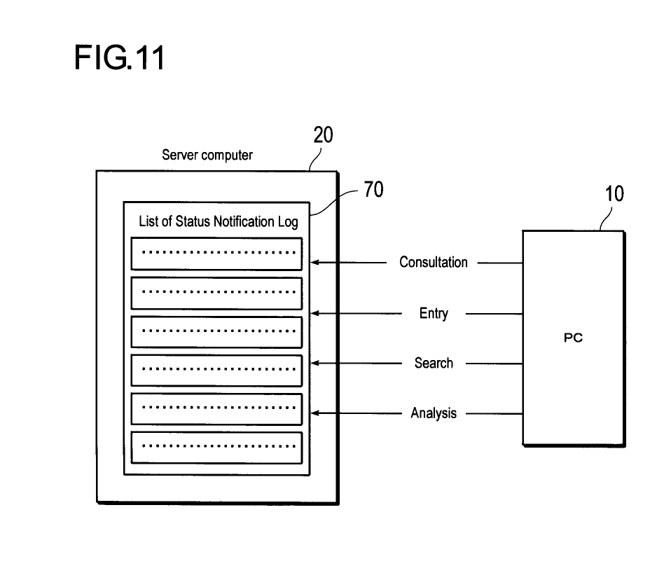

FIG. 11 is a diagram for describing an exemplary method of using viewable database.

As mentioned before, the server computer 20 can construct a reviewable database 70. The database 70 is customized in such a way that it not only allows the PC 10 to consult with the list of status notification log but also allows the PC 10 to write comments into the database 70. Moreover, the database 70 is customized in such a way that it allows searching or analyzing specific information in the database 70.

For example, this enables the PC 10 to display on the display 15 only the event information from the MFP, or to display only the event information from the selected MFP, or to display only the power source on/off event information, or to display only the user's comments, or to display only the paper replenish request event information, or to display the printing job start/finish event information, or to display the current power-on event information. Moreover, it can be constituted in such a way as to let the server computer 20 to calculate the MFP's operating time based on the power on/off event information and allow its result to be displayed in a graphic form on the display 15 of the PC 10.

As can be seen from the above, first of all, the MFP 30A, 30B transmits the event information to the server computer. Next, the server computer 20 constructs the database that can be viewed by the user using the received event information. The PC 10 consults with the server computer 20 concerning the necessary information based on the database. In other words, the PC 10 can acquire the necessary information specified by the user by requesting it from the server computer 20.

Therefore, the present embodiment can enable the user to efficiently mange the events occurred in the image forming device such as an MFP because additional information can be added by the user to the database of the events occurred in the image forming device.

Moreover, if Web server function is used when information based on the database is provided so that the information is user-viewable by the server computer, it can allows the user to manage a plurality of image forming devices, e.g., their operating statuses, with a simple structure without requiring a large scale dedicated managing system.

The present invention is not limited to the embodiment described above, but rather can be modified in a various way within the scope of the claims shown below.

For example, although an MFP is adopted as an image forming device in the embodiment described in the above, the invention is not limited to it. The invention is applicable to various other image forming devices such as printers and copying machines.

The means and method for executing various processes in the printing system according to the present embodiment can be materialized by either a dedicated hardware circuit or a programmed computer. Such a program can be provided by a computer readable storage medium such as a flexible disk or a CD-ROM or provided on-line via a network such as the Internet. In this case, the program stored in a computer readable storage medium is typically transferred to and stored in a storage unit such as a hard disk. Furthermore, such a program can be provided as a standalone application software program or can be built into the device's software as a function of the device.

The above-description of preferred embodiments is not meant to limit the scope of the claims to those particular embodiments.

What is claimed is:

1. An event information management method for managing event information in a system, the event information concerning events occurring in an image forming device, the system equipped with said image forming device, a server computer communicable with said image forming device, and a terminal device communicable with said server computer, comprising:
1) said image forming device transmitting said event information to said server computer;
2) said server computer constructing user-viewable database using the received event information; and
3) said terminal device consulting with said server computer for information based on said database.
4) said terminal device transmitting additional information, which is to be prepared by the user and to be added to said database, to said server computer.

2. The managing method as claimed in claim 1, wherein
said event can be selected by the user from a plurality of events.

3. The managing method as claimed in claim 1, wherein
said database is constituted of information arranged in time sequence.

4. The managing method as claimed in claim 1, wherein
said additional information is related to specific event information contained in said database.

5. The managing method as claimed in claim 1, wherein
information based on said database in said step 3) is event information of a specific item specified by the user.

6. The managing method as claimed in claim 1, wherein said system contains a plurality of image forming devices.

7. The managing method as claimed in claim 1, wherein
said server computer has functionality as a Web server.

8. A server computer communicable with an image forming device and a terminal device, comprising:
a network interface adapted to communicate with the image forming device and the terminal device; and
a control unit adapted to control the server computer, wherein
said control unit receives event information concerning an event generated in the image forming device from the image forming device through the network interface, constructs user-viewable database using the event information, and receives additional information, which is to be prepared by the user and to be added to said database, from the terminal device used for viewing of information based on said database to update said database.

9. The server computer as claimed in claim 8, wherein
said event can be selected by the user from a plurality of events.

10. The server computer as claimed in claim 8, wherein
said database is constituted of information arranged in time sequence.

11. The server computer as claimed in claim 8, wherein
said additional information is related to specific event information contained in said database.

12. The server computer as claimed in claim 8, wherein
the information based on said database is event information of a specific item specified by the user.

13. The server computer as claimed in claim 8, wherein
said network interface is communicable with a plurality of image forming devices.

14. The server computer as claimed in claim 8, wherein
said control unit has functionality as a Web server.
